(19) United States
(12) Patent Application Publication
(10) Pub. No.: US 2010/0318977 A1
(43) Pub. Date: Dec. 16, 2010

(54) JIT COMPILATION WITH CONTINOUS APU EXECUTION

(75) Inventors: Utz Bacher, Boeblingen (DE); Markus Deuling, Boeblingen (DE); Hartmut Penner, Boeblingen (DE)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/482,048

(22) Filed: Jun. 10, 2009

(51) Int. Cl. G06F 9/45; G06F 13/28

(52) U.S. Cl. 717/148; 710/24

(57) ABSTRACT

A multiprocessor computing system includes a direct memory access (DMA) engine, a main memory and a host processor including a just-in-time compiler (JIT) that converts bytecode into machine code in discrete executable superblocks (XSBs). The system also includes a system bus coupled to the host processor, the DMA engine and the main memory and allowing communication there between and an auxiliary processing unit (APU) coupled to the system bus and having a local memory, the APU receiving a first XSB from the JIT and storing it in the local memory and loading the one or more next XSBs for execution found in the header of the first XSB into the local memory via the DMA engine.

### BACKGROUND

The present invention relates to computing devices, and more specifically, to computing devices that include a just-in-time compiler and one or more auxiliary processing units (APU's).

The execution of Java and other bytecode-based languages are often handled by just-in-time compilers (JITs). In computing, just-in-time compilation (JIT), also known as dynamic translation, is a technique for improving the runtime performance of a computer program. JIT builds upon two earlier ideas in run-time environments: bytecode compilation and dynamic compilation. It converts code at runtime prior to executing it natively, for example bytecode into native machine code. The performance improvement over interpreters originates from caching the results of translating blocks of code executing native machine code with processor-specific optimizations, and not simply reevaluating each line or operand each time it is met. It also has advantages over statically compiling the code at development time, as it can recompile the code if this is found to be advantageous, and may be able to enforce security guarantees. Thus, JIT compilers can combine some of the advantages of interpretation and static (ahead-of-time) compilaters compilers.

Resource-efficient execution of utilizing JIT compilation may be difficult, however on modern multicore architectures that have heterogeneous structures with many cores with limited capabilities. These multicore architectures may include a host processor and several smaller auxiliary processors referred to herein as auxiliary processing units (APU's). Of course, the host processor may itself be composed of multiple cores. Today's JITs run only fragments (blocks) of whole code on such devices due to limited local store size in the APU's. After each code block, the JIT appends the next code blocks, depending on the result of the previous code block execution. This leads to interruptions in the execution flow as well as performance degradations; the JIT places new code blocks into the APU's memory and starts execution again.

As the industry is going towards such many-core architectures with small cores, improving JITs witch may become increasingly important.

### SUMMARY

According to one embodiment of the present invention, a multiprocessor computing system includes a direct memory access (DMA) engine, a main memory and a host processor including a just-in-time compiler (JIT) that converts bytecode into machine code in discrete executable superblocks (XSBs). Each XSB includes a header and a footer, the header including an identification of one or more next possible XSBs for execution. The JIT stores the XSB's in the main memory. The system also includes a system bus coupled to the host processor, the DMA engine and the main memory and allowing communication there between. The system also includes an auxiliary processing unit (APU) coupled to the system bus and having a local memory, the APU receiving a first XSB from the JIT and storing it in the local memory and loading the one or more next XSBs for execution found in the header of the first XSB into the local memory via the DMA engine.

Another embodiment of the present invention is directed to a method of continuously operating an auxiliary processing unit (APU) in a multiprocessor computing system including a system bus, a direct memory access (DMA) engine, a main memory, a host processor including a just-in-time compiler (JIT) and the APU. The method includes receiving bytecode at the JIT, converting the bytecode into executatable superblocks (XSBs), each XSB including a header, a superblock containing executable machine code instructions, and a footer; storing at least a second XSB in main memory; transferring a first XSB to the APU and storing it in a local memory of the APU; and reading the header to the XSB at the APU and causing one or more additional XSBs to be loaded into the local memory via the DMA engine based on information contained in the header.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows an example of a multi-processor computing system according to one embodiment of the present invention;

FIGS. 2a-2c, show examples, respectively, of a building block, a superblock and an executable superblock according to embodiments of the present invention;

FIG. 3 shows a plurality of executable superblocks and how branching between them may occur; and

FIG. 4 is a flow chart showing how an embodiment of the present invention may operate.

### DETAILED DESCRIPTION

Embodiments of the present invention may be directed to systems and methods for utilizing JIT compilation on a multi-core processor. In a typical JIT compiler (JIT), bytecode to be executed is split in basic blocks at a host processor. A basic block has one entry and one or two exit destinations, i.e. it is linear code or code that ends with a conditional branch to two different targets. In one embodiment of the present invention, the JIT runs on the host processor and translates bytecode into machine code that will run on an auxiliary processing unit (APU). Execution is efficient, when not only a few instructions, but a few hundred or thousand instructions are executed in one rush. Therefore, the first step generates superblocks from basis blocks. A number of basic blocks are put together to form a superblock. Like basic blocks, superblocks also have only one entry and one or two exits, i.e. at most two branches with targets that are external superblocks. Branches within the superblock are not limited. As the exit branch targets of a superblock are known, the succeeding superblocks are known as well, i.e., a superblock has a known size and known exit branch targets. Formation of superblocks from basic blocks takes place before execution starts; translation of superblocks can be done concurrently with execution. Superblocks are translated into position independent code. Some or all of the above is well known in the prior art and is done by conventional JIT's.

To make the superblocks usable for continuous APU execution according to the present invention, each superblock may be converted into an executable superblock (XSB). Each XSB contains a superblock proceeded surrounded by a header and a footer, both containing APU readable and executable code. The header code may cause the one or two XSBs that may follow the current block to be loaded, via direct memory access (DMA), into the local memory of the APU and causes those XSBs to be transferred into local memory of the APU. As XSBs are created by the JIT compiler, they may be stored in virtual/main memory of the multi-core processor. If a particular XSB is not yet translated, a stub will be placed into the header of the XSB that causes the execution to halt. The JIT can catch this exception and restart execution as soon as the superblock of the XSB has been translated. At the exit the XSB execution, the code in the XSB knows which XSB of those loaded by DMA to execute based on the conditions created by the execution of the instructions in the superblock. The footer may, in some cases, cause the XSB to wait on completion of the header's DMA transfer(s). Upon completion, the APU branches into the corresponding XSB.

In operation, the JIT places an XSB into the APU and starts execution. The header of the first XSB will load the following one or two XSB into local memory via DMA as described above. Also as described in above, if one of the XSBs is not translated yet, a stub will be used instead, that halts the flow of execution on the APU. The JIT on the host will then wait until enough code is translated and ready for execution and finally restart execution on the APU.

The actual translated bytecode of the superblock is then executed. After that, execution runs into the footer. This footer waits until the DMAs for succeeding XSBs has completed. The APU then branches into the appropriate XSB because, based on prior processing it “knows” which one of the two is the right XSB to continue execution in. Once the JIT cache is warm, execution of translated bytecode on the APUs is continuous. This may be in contrast to conventional approaches for such architectures that execute bytecode in chunks and then have to stop for setting up execution again.

As described above, it may be seen that embodiments of the present invention allow for the APUs to “pull” the needed code segments, as needed, via DMA. In this manner, control is not repeatedly transferred back and forth between the JIT and the APU in the conventional “push” scenario where the JIT pushes a portion of code to the APU, the APU executes it, returns a value to the JIT and then the JIT pushes the next code portion to the APU based on the value returned.

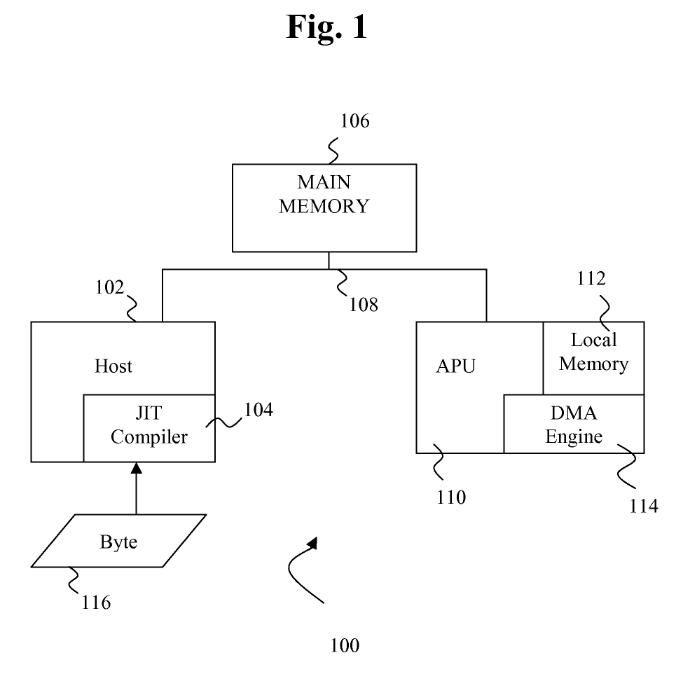

FIG. 1 shows an example of a multi-processor computing system 100 according to one embodiment of the present invention. In one embodiment, the system 100 may be a multi-core architecture (such as, for example, the Cell/B.E. processor architecture utilized in Sony Playstation 3 devices or IBM BladeCenter JS22 computer systems) having heterogeneous structures with many cores that each have limited capabilities. Of course, the teachings herein are limited to being implemented in a multiprocessor system as just described. The system 100 need only include two processors. Indeed, the two processors may be part of the same core and virtually separated from each other.

The system 100 includes a host processor 102 (host). The host 102 could be any type of processor. In one embodiment, the host 102 may be a multi-processor device. That is, the host 102 may include multiple processors. In one embodiment, the host 102 includes a JIT compiler 104. The JIT compiler 104 may be any type of available compiler. In one embodiment, the JIT compiler 104 is based on the open source Cacao compiler. Of course, regardless of the JIT compiler used, the JIT compiler 104 may be configured to create XSBs as described herein.

The system 100 may also include a memory 106 coupled to the host 102. The memory 106 may be so called “main memory” and should be accessible to a DMA engine. In one embodiment, the host is coupled to the memory 106 via a bus 108. Of course, the system 100 could couple the memory 106 directly to the host 102. Of course, the memory 106 could be at a location remote from other portions of the system 100 and could be implemented as a peripheral device.

The system 100 may also include one more APU's. As shown, the system 100 includes one APU 110. Of course, the system 100 is not so limited and may have any number of APU's. In one embodiment, the APU 110 may be the same type of processor as the host 102. In another embodiment, the APU 110 may be a smaller processor than the host 102 and having a limited instruction set. Examples of APU's include, but are not limited, graphics accelerators and input/output devices.

The APU 110 may include local memory 112 and a DMA engine 114. The DMA engine 114, as shown, is part of the APU 110 but may be a separate unit. Regardless, the DMA engine 114 may allow the APU 110 to retrieve information from memory 106 and place that memory in local memory 112 and vice-versa.

It should be understood, that while the JIT compiler may be located on the host 102 it may convert the bytecode 116 into machine code executable on the APU 110.

In operation, the system 100 may operate as follows. First, byte code 116 for computer code (which may be stored, for example, in memory 106) is loaded into the host 102. The host 102 causes the JIT compiler 104 to convert the byte code 116 into machine code. The machine code is formed into XSBs as described in greater detail below. The XSBs may then be stored in memory 106. The first XSB to be operated upon is loaded into the APU 110 under the control of the host 102. As described above, the APU 110 determines, from information contained in the first XSB, the next one or two XSBs to be loaded into the APU 110. These two XSBs are then loaded into the APU 110 by the DMA engine 114. It shall be understood that the loading of additional XSBs will not require intervention of the host 102 because, as described above, the XSBs themselves include instructions that allow the APU 110 to determine the next XSB to load. This is different than in the prior art where a host processor pushed a first superblock to a peripheral device, waited for the peripheral to complete the code and then had to determine the next superblock to push to the peripheral based on information returned back from the peripheral.

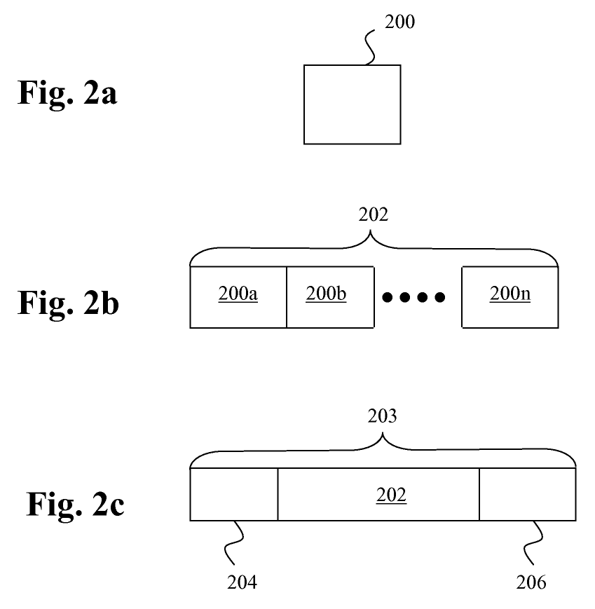

FIGS. 2a-2c, respectively, show a basic block 200, a superblock 202 and an XSB according to an embodiment of the present invention. In particular, FIG. 2a shows a basic block 200. The basic block 200 is a small set of machine instructions created from the bytecode by the JIT compiler. A basic block 200 may be variable in size and may only have one entry point with one or two exits. That is, a basic block is either linear code of a certain size or code that ends with a branch to one of two different targets. A basic block may not have any jump instructions for jumps to locations internal or external to the basic block 200.

FIG. 2b shows a superblock 202. A superblock 202 is, in general, a collection of two or more basic blocks 200a . . . 200n. Of course, the size of a particular superblock 202 may be limited. Like basic blocks, superblocks also have only one entry and one or two exits, i.e. at most two branches with targets that are external superblocks. Unlike basic blocks, branches within the superblock 202 are not limited. As the exit branch targets of a superblock are known, the succeeding superblocks are known. This information will be used for the creation of an XSB.

FIG. 2c shows an example of an XSB 203 according to one embodiment. the XSB 204 includes a header 204, a superblock 202 and a footer 206. As discussed briefly above, the header 204 contains the one or two next possible branch targets for the XSB 204. This information is known by the JIT compiler as it compiles the bytecode. To this end, the header 204 may also be referred to as a “load next” block and may be used by the APU to load the one or two next possible XSBs from main memory into local memory via DMA. The footer contains a DMA wait command. This command will cause the APU to wait until the required next XSBs are loaded into local APU memory before proceeding to the XSB.

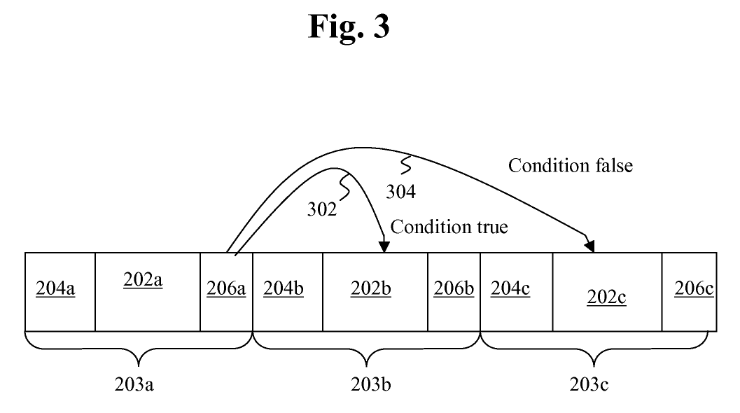

FIG. 3 shows a conceptual view of the local memory of the APU while in operation according to an embodiment of the present invention. A first XSB 203a is loaded into the local memory. This first XSB 203a may be loaded based on a prior branch or may be the first XSB loaded based on an instruction from the host (caused by the JIT compiler).

Regardless, the first XSB 203a has a first header 204a and a first footer 206a. As discussed above, the first header 204a may include the one or two (in this example, two) XSBs that may possibly follow the first XSB 203a in execution of the current code. The APU reads this first header 204a and is directed to cause the DMA engine to load a second XSB 203b and a third XSB 203c. While the second XSB 203b and third XSBs 203c are being loaded, the APU performs the instructions in the first superblock 202a. These instructions are sequentially performed until the APU reaches the end of the first superblock 202a. At that time, the APU encounters the first footer 204c which may also be referred to herein as a DMA wait block. In the event that the DMA transfer of both the possible next XSBs is not complete (or at least the XSB that is to branched to) because the XSBs have not been created by the JIT compiler (i.e., they don't exist yet in main memory), the DMA wait block 203a instructs the APU to transfer control back to the JIT and await a notification that the XSB of the next branch is available. In the event the XSBs are already in memory, no waiting is required. As discussed above, it may be determined that the next XSB is not ready as it is represented as a dummy XSB in the form of a stub.

As discussed above, the first XSB 203a has only one or two possible branch destinations. In this example, the possible destinations are the second XSB 203b and the third XSB 203c. At the end of the superblock 202a in the first XSB 203a, the destination of the branch is known. In this example, if the branch condition has a true value, the APU branches to the second XSB 203b as indicated by arrow 302. Otherwise, the APU branches to the third XSB 203c. Regardless, the same process described above begins again with the branch destination assuming the place of the first XSB.

In this manner, the number of times that control is passed between JIT compiler and the APU is reduced. After a warm up time it may be assumed that the JIT compiler has compiled and stored every XSB. In such an instance, after control is originally passed from the JIT compiler to the APU, control may not need to passed back to the JIT compiler.

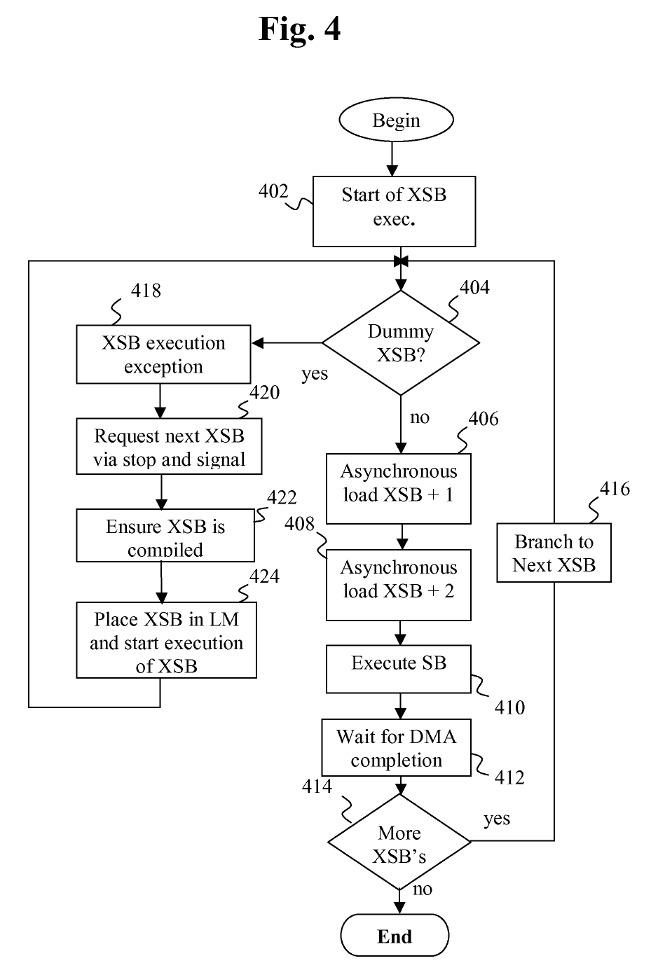

FIG. 4 shows a flow chart of a method of continuous operation of an APU according to one embodiment of the present invention. The method begins at a block 402 where the JIT compiler transfers a first XSB to the APU for operation. At this time control is passed from the JIT compiler to the APU. At a block 404 it is determined if the XSB is a dummy XSB. The first time that the flowchart shown in FIG. 4 is traversed the XSB should always or almost always not be a dummy XSB because the JIT would normally transfer control to the APU until it prepared the first XSB. The operation of block 404 becomes more important in subsequent passes as is explained later below.

In the event that the XSB is not a dummy XSB, at a block 406 the first possible next XSB (contained in the header—denoted as XSB+1) is loaded into the local memory of the APU. In one embodiment, the XSB is asynchronously loaded from main memory to the APU local memory by a DMA transfer. At a block 408, the other possible next XSB (also contained in the header—denoted XSB+2) is similarly loaded into the local memory of the XSB.

At a block 410, the instructions contained in the superblock portion of the first XSB are executed. At the end of the instructions, the next XSB is known as discussed above. At a block 412, the process waits until the DMA transfer is complete. Of course, the DMA may be complete before the superblock instruction are done being processed. In such a case, there is no waiting required.

Regardless, at a block 414 it is determined if the process is completed by determining if there are any more XSB branches. If not, the process ends. If so, at a block 416 the next XSB is branched to. This next XSB may now be thought of as the first XSB described above and the process repeats.

In the event that at block a 404 it is determined that the first XSB is a dummy XSB (i.e., has not yet been compiled), at a block 418 the APU generates, in one execution exception or interrupt. At a block 420, the APU informs the JIT compiler that a particular XSB needed for execution is not ready. At this point control is passed back to the JIT compiler which, at a block 422 determines when the required XSB is completed. When completed, the XSB is loaded into local memory of the APU at a block 424. Control is then returned to the APU and processing returns to block 404.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A multiprocessor computing system, the system comprising:
a direct memory access (DMA) engine;
a main memory;
a host processor including a just-in-time compiler (JIT) that converts bytecode into machine code in discrete executable superblocks (XSBs), each XSB including a header and a footer, the header including an identification of one or more next possible XSBs for execution, the JIT storing the XSB's in the main memory;
a system bus coupled to the host processor, the DMA engine and the main memory and allowing communication there between; and
an auxiliary processing unit (APU) coupled to the system bus and having a local memory, the APU receiving a first XSB from the JIT and storing it in the local memory and loading the one or more next XSBs for execution found in the header of the first XSB into the local memory via the DMA engine.

2. The system of claim 1, wherein the DMA engine is coupled between the APU and the system bus.

3. The system of claim 1, wherein in the event that the JIT has not yet compiled a one of the one or two next possible XSBs, a dummy XSB is employed as a one of the one or two next possible XSBs.

4. The system of claim 1, wherein the footer includes an instruction that causes the APU to halt execution in the event that a one of the one or two next possible XSBs has not yet been compiled.

5. The system of claim 1, wherein the APU determines the next on the one or two possible XSBs to branch to based on the results of calculations made during execution of the first XSB.

6. The system of claim 5, wherein following the determination, the APU loads the one or two new next possible XSBs contained in a header a portion of the branched to next XSB.

7. The system of claim 1, wherein a one of the two next possible XSBs becomes a second XSB having a second header a including an identification of a second one or more next possible XSBs for execution.

8. The system of claim 7, wherein the second XSB includes a second footer including a wait instruction causing the APU to wait until a DMA transfer is complete.

9. The system of claim 1, wherein the JIT converts the bytecode into machine code in a format understandable by the APU.

10. The system of claim 1, further comprising:
one or more additional DMA engines;
one or more additional APUs coupled to the system bus and having a local memory and each being coupled to a different one of the one or more DMA engines, the APU receiving an XSB from the JIT and storing it in the local memory and loading the one or more next XSBs for execution found in the header of the first XSB into the local memory via the DMA engine

11. The system of claim 10, wherein the one or more additional APUs include a smaller instruction set than the host processor.

12. The system of claim 10, wherein at least two of the additional APUs are of the same type.

13. A method of continuously operating an auxiliary processing unit (APU) in a multiprocessor computing system including a system bus, a direct memory access (DMA) engine, a main memory, a host processor including a just-in-time compiler (JIT) and the APU, the method comprising:
receiving bytecode at the JIT;
converting the bytecode into executatable superblocks (XSBs), each XSB including a header, a superblock containing executable machine code instructions, and a footer;
storing at least a second XSB in main memory;
transferring a first XSB to the APU and storing it in a local memory of the APU; and
reading the header to the XSB at the APU and causing one or more additional XSBs to be loaded into the local memory via the DMA engine based on information contained in the header.

14. The method of claim 13, further comprising:
executing the machine code instructions on the APU; and
branching to a one of the one or more additions XSB loaded into the local memory based on a value determined while executing the machine code instructions.

15. The method of claim 14, further comprising:
reading a supplemental header of the XSB branched to;
loading one more supplemental additional XSBs to be loaded into the local memory via the DMA engine based on information contained in the supplemental header.

16. The method of claim 14, further comprising:
before branching, determining if all of the one or more additional XSBs have been loaded into the local memory; and
halting operation on the APU in the event that all of the one or more additional XSBs have not been loaded into the local, otherwise, reading a reading a supplemental header of the XSB branched to.
